(19) United States
(12) Patent Application Publication
(10) Pub. No.: US 2026/0273463 A1
(43) Pub. Date: Sep. 17, 2026

(54) REDUCTION OF NOx EMISSIONS FROM SEMICONDUCTOR PROCESS TOOLS

(71) Applicant: Taiwan Semiconductor Manufacturing Company, Ltd., Hsinchu (TW)

(72) Inventors: Chih-Ming Tsao, Miaoli (TW); Chieh Pu Lai, Taichung (TW)

(21) Appl. No.: 19/079,617

(22) Filed: Mar. 14, 2025

(51) Int. Cl. B01D 53/75; B01D 53/34; B01D 53/56; B01D 53/76; B01D 53/86

(52) U.S. Cl. CPC B01D 53/75; B01D 53/346; B01D 53/56; B01D 53/76; B01D 53/8628; B01D 53/8631; B01D 2251/102; B01D 2255/2073; B01D 2255/707; B01D 2257/404; B01D 2258/0216

(57) ABSTRACT

A catalytic reactor is included in a local scrubber of a semiconductor process tool to convert NO and NO₂ into higher-order nitrogen oxides for subsequent removal by a central air treatment system. Reactive oxygen species are provided by an ambient temperature plasma generator. Reducing agents such as ammonia are not needed, and NOx removal efficiency is greatly increased.

### BACKGROUND

Integrated circuits are formed on a semiconductor wafer. Desired materials are deposited to form a layer on a semiconductor wafer. Photolithographic patterning processes use ultraviolet light to transfer a desired mask pattern to a photoresist layer formed upon the material layer. Etching processes may then be used to transfer the pattern to the material layer below the photoresist. This process is repeated multiple times with different patterns to build different layers on the wafer substrate and make a useful device. Waste gases created during the manufacturing process need to be controlled.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic illustration showing a semiconductor process tool and components for controlling exhaust therefrom, in accordance with some embodiments of the present disclosure.

FIG. 2 is a magnified schematic illustration of the local exhaust system for the semiconductor process tool.

FIG. 3 is a perspective view of a catalytic reactor for advanced oxidation/reduction of nitrogen oxides (NOx).

FIGS. 4A-4D are illustrations of a monolith support used in the catalytic reactor at different magnifications.

FIG. 5A and FIG. 5B are illustrations of the chemical reactions that occur between nitrogen oxides and reactive oxygen species (ROS) within the catalytic reactor.

FIG. 6 is a flow chart illustrating a method for making a catalytic reactor and upgrading or retrofitting a local exhaust system, in accordance with some embodiments.

FIG. 7 is a flow chart illustrating a method for using the catalytic reactor and the local exhaust system, in accordance with some embodiments.

FIG. 8 is a bar graph showing NOx removal efficiency versus retention time for two different catalysts.

FIG. 9 is a bar graph showing NOx removal efficiency versus relative humidity for two different catalysts in the presence of other gases.

FIG. 10 is a bar graph showing NOx removal efficiency versus temperature for two different catalysts.

FIG. 11 is a bar graph showing NOx removal efficiency versus pH for two different catalysts.

FIG. 12 is a schematic illustration showing how the stacking of various exhaust control processes can improve NOx removal efficiency.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Numerical values in the specification and claims of this application should be understood to include numerical values which are the same when reduced to the same number of significant figures and numerical values which differ from the stated value by less than the experimental error of conventional measurement technique of the type described in the present application to determine the value. All ranges disclosed herein are inclusive of the recited endpoint.

The term “about” can be used to include any numerical value that can vary without changing the basic function of that value. When used with a range, “about” also discloses the range defined by the absolute values of the two endpoints, e.g. “about 2 to about 4” also discloses the range “from 2 to 4.” The term “about” may refer to plus or minus 10% of the indicated number.

The terms “inlet” and “outlet” are relative to a fluid (e.g. gas) flowing through them with respect to a given structure, e.g. a fluid flows through the inlet into the structure and flows through the outlet out of the structure. The terms “upstream” and “downstream” are also relative to the direction in which a fluid flows through various components, i.e. the flow fluids through an upstream component prior to flowing through the downstream component.

The term “fluidly connected” is used in the specification to indicate that two components are connected to each other in such a way that a fluid in one component will eventually reach the second component. This term permits other structures and components to be present between the two fluidly connected components.

The term “directly” is used to indicate that the fluid in the first component subsequently flows into the second component, with no other components between them that affect the makeup of the fluid.

The present disclosure may refer to temperatures during certain process steps. It is noted that these generally refer to the temperature of the environment for that given process step, and do not necessarily refer to the temperature which must be attained by any particular material that is in the environment.

The present disclosure relates to structures which are made up of different layers. When the terms “on” or “upon” or “over” are used with reference to two different layers (including the substrate), they indicate merely that one layer is on or upon or over the other layer. These terms do not require the two layers to directly contact each other, and permit other layers to be between the two layers. For example all layers of the structure can be considered to be “on” the substrate, even though they do not all directly contact the substrate. The term “directly” may be used to indicate two layers directly contact each other without any layers in between them. In addition, when referring to performing process steps to the substrate or upon the substrate, this should be construed as performing such steps to whatever layers may be present on the substrate as well, depending on the context.

The present disclosure relates to methods and systems for treating exhaust gases produced by semiconductor process tools of a semiconductor fabrication plant. Integrated circuits are typically formed by deposition and etching of various materials, for example various metals and dielectric materials or precursors such as silicon dioxide (SiO₂). These processing steps are performed in process tools that result in process waste gases containing materials such as perfluorocarbons (PFCs) and/or nitrous oxide (N₂O). Each process tool includes a local scrubber that treats the waste gases in-situ before discharge to a central air abatement system. This is typically done by thermal oxidation, which generates nitrogen oxides (NOx), in particular nitric oxide (NO) and nitrogen dioxide (NO₂). NO and NO₂ are respiratory irritants and it is desirable to remove such irritants prior to discharge to the central air abatement system. Conventional selective/selective non-catalytic reduction (SCR/SNCR) processes for reduction of NOx require high temperatures (for example 350° C. to 1038° C.) and the use of reducing agents such as ammonia, which is difficult to control and slip problems can occur, resulting in additional ammonia emissions (which is also undesirable). In addition, the NOx reduction efficiency of SCR/SNCR is usually very low (<50%).

In the present disclosure, a catalytic reactor is added to the local scrubber to reduce NOx emissions. Ambient temperature plasma (also known as cold plasma) is used to generate reactive oxygen species (ROS) that react with NO and NO₂ in the presence of a catalyst to convert them into highly oxidized nitrogen oxides. The process is fast, and can be conducted at ambient temperature without the need for reducing agents or a complex atmosphere.

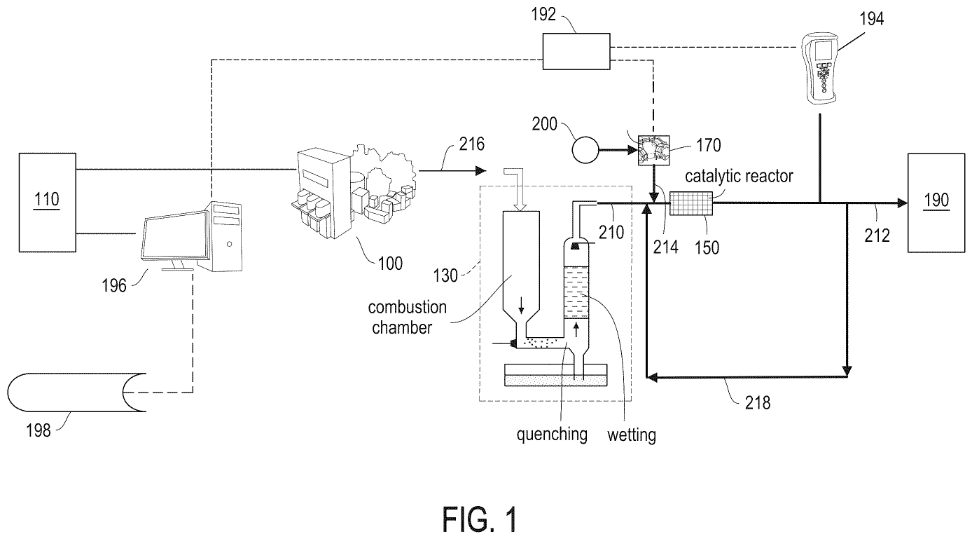

FIG. 1 is a schematic illustration showing a semiconductor process tool 100 and components for controlling exhaust therefrom, in accordance with some embodiments of the present disclosure.

In some particular embodiments, the semiconductor process tool 100 is a deposition tool that performs physical vapor deposition (PVD) or chemical vapor deposition (CVD), both of which are used to deposit a thin film of material over a wafer substrate. The PVD process is carried out at high vacuum in a process chamber containing a solid target of the material to be deposited on the substrate. The PVD target is physically converted from a solid into a vapor, and the vapor is transported from the target to the substrate where it condenses as a thin film. Examples of PVD processes include evaporation, e-beam evaporation, plasma spray deposition, and sputtering. Presently, sputtering is the most frequently used method for accomplishing PVD. In CVD, rather than using a solid target, volatile gaseous precursors react and/or decompose to produce the desired layer upon the substrate. In other embodiments, the semiconductor process tool 100 is a dry etch tool, such as a plasma etch tool. Generally, a patterned mask (e.g. photoresist) is formed upon the substrate that exposes material which is desired to be removed. A plasma is formed from reactive gases to create ions that then bombard and remove the exposed material, leaving behind the desired pattern.

More generally, the semiconductor process tool is a dry process tool, or a process tool where the only waste products are gases. Inputs to such semiconductor process tools may include gaseous materials such as perfluorocarbons (PFCs), etchant gases, and carrier gases. Depending on the material, examples of such gases may include etchants such as nitrous oxide (N₂O), carbon tetrafluoride (CF₄), hexafluoroethane (C₂F₆), octafluoropropane (C₃F₈), difluoromethane (CH₂F₂), fluoromethane (CH₃F), trifluoromethane (CHF₃), carbon fluorides, nitrogen (N₂), hydrogen (H₂), oxygen (O₂), argon (Ar), xenon (Xe), xenon difluoride (XeF₂), helium (He), carbon monoxide (CO), carbon dioxide (CO₂), fluorine (F₂), chlorine (Cl₂), hydrogen bromide (HBr), hydrofluoric acid (HF), nitrogen trifluoride (NF₃), sulfur hexafluoride (SF₆), boron trichloride (BCl₃), ammonia (NH₃), bromine (Br₂), nitrogen trifluoride (NF₃), or the like, or combinations thereof in various ratios. For example, silicon dioxide can be dry etched using various mixtures of CHF₃, O₂, CF₄, and/or H₂.

The operations of the semiconductor process tool 100 can be monitored and/or controlled by a fault detection system operating on controller 110, as illustrated here. The controller may receive input from various sensors (not illustrated) to control various parameters such as various gas flows, pressures, temperatures, movement of components, opening/closing of doors, control of robotic arms, etc. to perform a given manufacturing step upon the semiconducting wafer substrate. The controller may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLC, PLD, PLA, FPGA, Graphical card CPU (GPU), or PAL, or the like. Such devices typically include at least memory for storing a control program (e.g. RAM, ROM, EPROM) and a processor for implementing the control program.

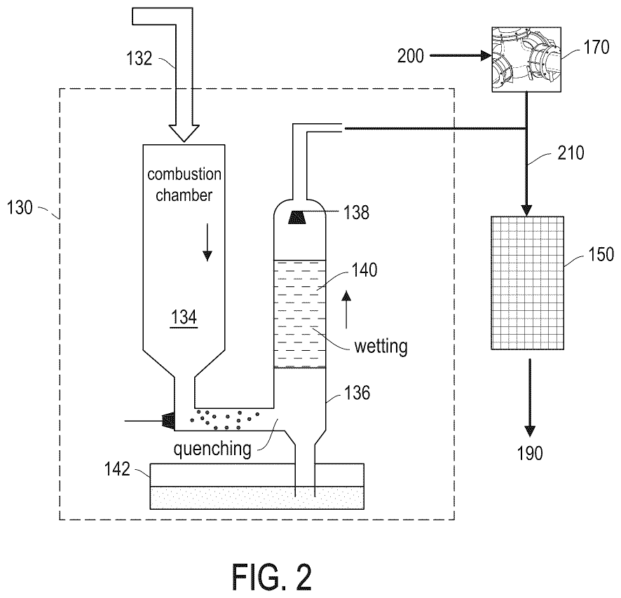

The waste gas(es) generated by the semiconductor process tool 100 are sent to a local scrubber 130. A magnified view of the local scrubber 130 is also seen in FIG. 2. The local scrubber is located near the semiconductor process tool 100, and is fluidly connected to the exhaust outlet of the semiconductor process tool 100, and generally treats the waste gas(es) generated by one process tool. In contrast, a “central” scrubber or treatment system receives or collects the exhaust from several local scrubbers.

The waste gas(es) enter the local scrubber through an inlet 132. The local scrubber includes a combustion chamber 134 fluidly connected to a liquid wash chamber 136 downstream. In the combustion chamber, the waste gas(es) are thermally oxidized (i.e. incinerated) at high temperature to decompose the waste gas(es) into an exhaust gas containing desirable products such as oxygen (O₂), nitrogen (N₂), carbon dioxide (CO₂), and/or water (H₂O). Temperatures in the combustion chamber may range, for example, from about 800° to about 1500° C., although other temperatures and ranges are within the scope of this disclosure.

Due to incomplete combustion, the exhaust gas will also contain undesirable products like nitrogen oxides (NOx), in particular nitric oxide (NO) and nitrogen dioxide (NO₂). Other corrosive molecules may also be present in the exhaust gas, such as hydrofluoric acid (HF), carbonyl fluoride (COF₂), and shorter-chain PFCs. The exhaust gas then travels to the liquid wash chamber 136. There, the exhaust gas passes through a scrubbing liquid distributed, for example, by a showerhead 138 though a packed bed 140 to remove pollutants and neutralize acidic gases. The scrubbing liquid can then be collected, treated, and/or recycled.

After treatment in and upon exiting the local scrubber 130, the exhaust gas may have a pH of, for example, about 5 to about 7, or about 7. The exhaust gas is then fed into a catalytic reactor 150 through line 210.

In addition, an ambient temperature plasma generator 170 generates reactive oxygen species (ROS). Ambient temperature plasma can be generated through dielectric barrier discharge (DBD), where a high voltage alternating current is passed between two electrodes separated by an insulator. In the present disclosure, this may also be performed at atmospheric pressure. The plasma may be generated from air (containing both oxygen and nitrogen) or concentrated oxygen. A carrier/operating gas, such as helium or argon, may also be present. In particular embodiments, the ambient temperature plasma generator 170 may operate at temperatures between about 20° C. and about 40° C., although other ranges and values are within the scope of the present disclosure. The generated ROS are also fed into the catalytic reactor 150.

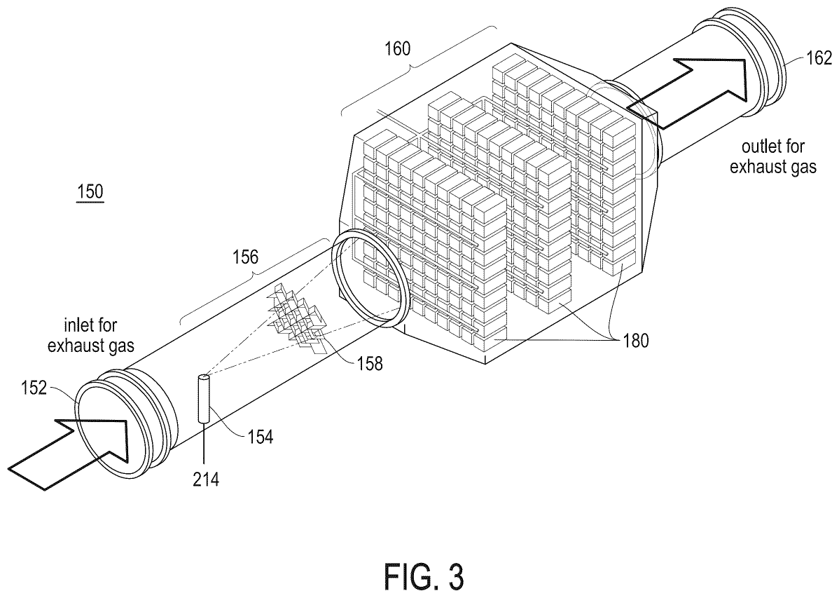

FIG. 3 is a perspective view of an example catalytic reactor 150, in accordance with some embodiments of the present disclosure. As illustrated here, the catalytic reactor includes an inlet 152 for the exhaust gas. An ROS injection port 154 is fluidly connected to, and receives ROS from, the ambient temperature plasma generator through outlet line 214. In this embodiment, the inlet is in the form of a mixing chamber 156 that receives the incoming exhaust gas and includes the ROS injection port. A mixer 158 promotes mixing of the ROS and the exhaust gas within the mixing chamber. The inlet 152 then leads to a reaction chamber 160, and an outlet 162 provides an exit for the exhaust gas from the reaction chamber. In particular embodiments, no other nitrogen-containing reducing agent, such as ammonia or urea, is injected into the catalytic reactor.

The reaction chamber of the catalytic reactor 150 contains a catalyst which is suitable for converting NO and NO₂ in the exhaust gas into higher-order nitrogen oxides. Such higher-order nitrogen oxides may be, for example, of the formula NₓO_{y}, where x and y are both integers and x is greater than or equal to 2 (i.e. x≥2). Some non-limiting examples of high-order nitrogen oxides may include N₂O₄ and N₂O₅. In some specific embodiments, x is 2 or 3, and y is 3 to 7.

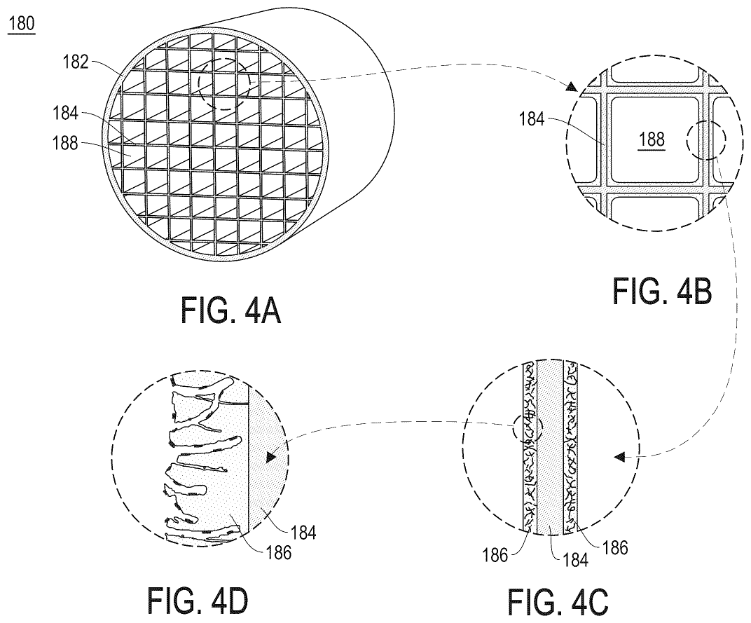

The catalyst may be impregnated into a monolithic support 180. As illustrated in FIG. 3, three such supports 180 are present in the reaction chamber. FIGS. 4A-4D are illustrative views of the monolithic support at different magnifications. As illustrated in FIG. 4A, the support 180 includes a frame 182 having an internal volume. Here, the frame has a circular shape. Referring to both FIG. 4A and the magnified view of FIG. 4B, a plurality of walls 184 pass through the internal volume across opposite sides of the frame, forming passages 188 through which the mixture of the exhaust gas and the ROS pass. As illustrated here, the walls are arranged to form passages with a rectangular cross-section, but other cross-sectional shapes are also contemplated, such as triangular, hexagonal, etc. In some particular embodiments, the monolithic support, i.e. the frame 182 and the walls 184, are made of cordierite, which is resistant to thermal shock that may occur at high temperatures and/or large temperature swings. Other suitable materials are also within the scope of the present disclosure.

Although not illustrated, one or more walls can include perforations or holes along their length. The presence of such holes increases the reaction area, and may also create turbulence within the gas flow that enhances contact of NO and NO2 with the catalyst to enhance decomposition.

Referring now to the further magnified view of FIG. 4C, in particular embodiments, the catalyst is illustrated as a porous coating 186 on the walls 184 of the support. As illustrated here, the coating is present on both sides of the wall. The catalytic coating can also be present on the inner surface of the frame 182 as well. FIG. 4D shows a magnified view of the coating 186. The catalyst may be available in the form of macropores and mesopores within the coating that contain the active components.

In particular embodiments, the monolithic support may be in the form of a cartridge that is inserted into the catalytic reactor. It is contemplated that the cartridge is removable and replaceable, and can be replaced when the catalytic activity is reduced below desirable operating values. Generally, the cross-section of the catalytic reactor and the monolithic support, when viewed along an axis between the inlet and the outlet of the catalytic reactor, may be any suitable shape, such as a rectangle, a circle, a hexagon, etc. The dimensions of the catalytic reactor and the monolithic support are related to the desired size of the catalytic area and the residence/retention time of exhaust gas within the catalytic reactor.

A vertical opening ratio can be defined by the open area of each passage divided by the total area of the monolithic support (or in other words including the area taken up by the walls) along the axis of gas flow. In particular embodiments, the vertical opening ratio is at least 95%, although other values are within the scope of the present disclosure. Generally, a higher vertical opening ratio is desired to avoid a large pressure drop within the catalytic reactor. In addition, the passages should generally be open, or in other words no obstructions should be present within the passages. This also avoids a large pressure drop.

Referring back to FIG. 1, the exhaust gas exiting the catalytic reactor 150 through line 212 has a reduced concentration of NO and NO₂ (when considered together) compared to the exhaust gas entering the catalytic reactor in line 210. In some particular embodiments, the concentration is reduced by 85% or more, including 90% or more, or 95% or more. The exhaust gas exiting the catalytic reactor also has a higher concentration of higher-order nitrogen oxides compared to the exhaust gas entering the catalytic reactor.

The exhaust gas exiting the catalytic reactor subsequently passes to a central air treatment system 190. The central system receives the treated exhaust gas from multiple local scrubbers and further scrubs the exhaust gas. For example, the higher-order nitrogen oxides generated by the catalytic reactor 150 can be captured through absorption within the central air treatment system.

The semiconductor process tool 100 is usually located on a cleanroom floor, where the environment is controlled to maintain a very low level of airborne particles or contaminants that could affect the semiconductor chips that are being made. The local scrubber 130 is typically located on a sub-fab level, which is usually located below the cleanroom. The operations of the local scrubber 130, the ambient temperature plasma generator 170, and the catalytic reactor 150 can be monitored and controlled using a separate or second controller 192, which is like the controller previously described. For example, the controller could change the air/fuel ratio of the combustion chamber, control the temperature, mix various airflows, change the flame pattern, etc. The controller may receive input from various sensors to improve the performance of the exhaust system. For example, as illustrated here, an NOx inline sensor 194 may be used to measure the concentration or amount of NOx exiting the catalytic reactor. This information is used as an input to the controller 192, for example to change the amount of ROS being produced by the ambient temperature plasma generator 170. For example, here, the controller may be implemented as a control program running on a PLC.

The second controller 192 may also receive information and direction from an adaptive scrubber management system 196. Pollutant data can be collected from the NOx inline sensor 194 and other sensors as desired. Wafer throughput and other utility data also receive and provide information from the fault detection system operating on controller 110 of the cleanroom floor, as well as other databases 198. The user/operator can provide input and also receive feedback from the controller through the management system. This information can be used to computer a suitable power input for the ambient temperature plasma generator 170 using an autonomous algorithm. The controller 192 can then provide electricity/power to the plasma generator as needed. It is noted the adaptive scrubber management system 196 and the database 198 are illustrated separately, but may represent programs running, for example, on controller 110.

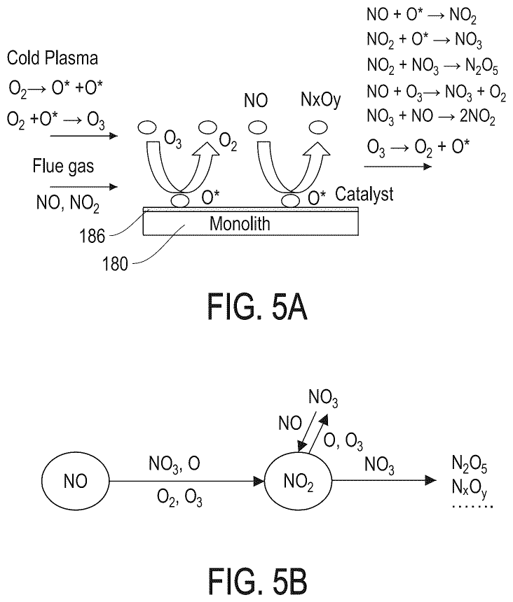

FIG. 5A and FIG. 5B are illustrations of the chemical reactions that occur between nitrogen oxides and reactive oxygen species (ROS) within the catalytic reactor. Referring first to FIG. 5A, the monolithic support 180 with a catalytic coating 186 is illustrated. Initially, the incoming exhaust gas or flue gas contains NO and NO₂.

The ambient temperature plasma generator provides reactive oxygen species (ROS) which are identified in the form of O*. As indicated, diatomic oxygen can form two ROS, O*. The ROS can react with diatomic oxygen (O₂) to form ozone (O₃). As illustrated, the catalyst can decompose ozone (O₃) to diatomic oxygen (O₂) and an ROS, O*. Continuing, then, as indicated in FIG. 5B, NO can react with NO₃, O*, O₂, or O₃ to form NO₂. NO₂ can react with O* or O₃ to form NO₃. NO₂ and NO₃ can react to form N₂O₅. More generally, NO and NO₂ can be reacted to form higher-order nitrogen oxides of the formula NₓO_{y}, as previously described. Ozone levels may also be reduced as the ozone is reduced to diatomic oxygen and O*. These reactions occur using the catalyst.

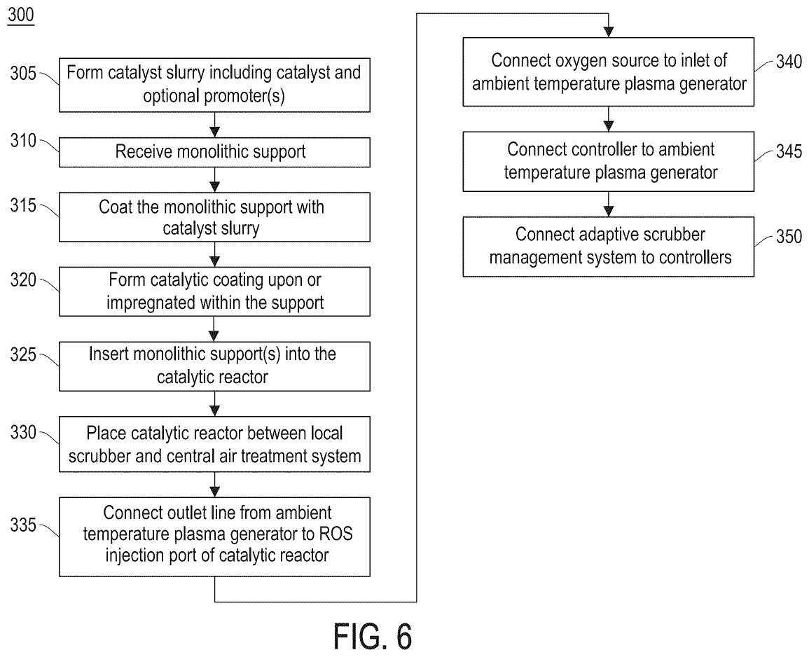

FIG. 6 is a flow chart illustrating a method 300 for making a catalytic reactor and a local exhaust system, in accordance with some embodiments. Some steps of the method are also illustrated in FIGS. 3-4D. While the method steps are discussed below in terms of making one catalytic reactor and one local exhaust system, such discussion should also be broadly construed as applying to making multiple catalytic reactors and multiple local exhaust systems. It is noted that not all steps described in the flow chart are required, and not all method steps are described in the flow chart.

Initially, in step 305 of FIG. 6, a catalyst slurry is formed that contains the catalyst and optionally one or more promoters. In particular embodiments, the catalyst is manganese (Mn), which can be provided in the form of an oxide such as MnO or MnO₂. If desired, a promoter may also be included. The use of a promoter significantly increases surface oxygen vacancies and enhances the activity of the catalyst. Examples of promoters may include iron (Fe), cobalt (Co), and cerium (Ce). The promoters may also be provided in the form of an oxide, such as FeO, Fe₂O₃, Co₃O₄, or CeO₂. In some particular embodiments, the molar ratio of catalyst to promoter is from about 1.5:1 to about 2.5:1, including about 2:1. In some embodiments, the liquid/solvent in the slurry may be a combination of water and an aqueous acid, such as nitric acid. In particular embodiments, the catalyst slurry (and the resulting catalytic coating) do not contain elements such as aluminum (Al), calcium (Ca), strontium (Sr), barium (Ba), lanthanum (La), silver (Ag), indium (In), nickel (Ni), titanium (Ti), or platinum (Pt).

Next, in step 310 of FIG. 6, a monolithic support 180 is received. As previously described in FIGS. 4A-4D, the support 180 includes a frame 182 and walls 184 upon which a catalytic coating will be formed. Then, in step 315 of FIG. 6, the monolithic support is coated with the catalytic slurry. This may be done by any suitable method, such as dip coating the support into the slurry, spraying the slurry onto the support, etc. In step 320 of FIG. 6, the slurry solvent is driven off to form a catalytic coating upon the support or impregnated within the support. This may be done, for example, by baking the coated monolithic support, and optionally at a low pressure to enhance vaporization of the solvent.

In step 325 of FIG. 6 and referring to FIG. 3, one or more monolithic supports 180 are inserted into the catalytic reactor 150. For example, FIG. 3 includes three supports 180 in the reaction chamber of the catalytic reactor.

Continuing then, and referring back to FIG. 1, a local scrubber 130 is an existing component of a local exhaust system 120, with the output of the local scrubber going to the central air treatment system 190. The local exhaust system can be upgraded or retrofitted with the catalytic reactor and ambient temperature plasma generator.

In step 330 of FIG. 6, the catalytic reactor is placed in the exhaust stream between the local scrubber 130 and the central air treatment system 190. Then, in step 335 of FIG. 6, an outlet line 214 from an ambient temperature plasma generator 170 is fluidly connected to the ROS injection port 154 of the catalytic reactor.

In step 340 of FIG. 6, an oxygen source 200 is fluidly connected to an inlet of the ambient temperature plasma generator. The oxygen source can provide air or concentrated diatomic oxygen (O₂). In step 345 of FIG. 6, a controller 192 is connected to the ambient temperature plasma generator. (It is contemplated the controller 110 and the NOx inline sensor 194 may already be part of the local exhaust system.) In step 350 of FIG. 6, the adaptive scrubber management system 196 is connected to both controllers 110, 192.

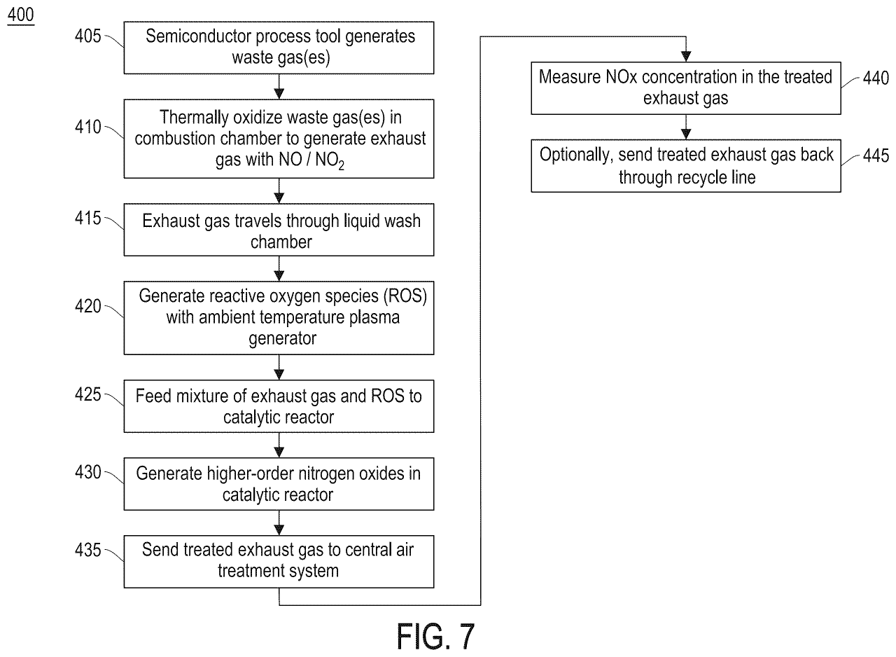

FIG. 7 is a flow chart illustrating a method 400 for using the catalytic reactor 150 and the local exhaust system 120, in accordance with some embodiments, to improve capture of nitrogen oxides from an exhaust gas. Some steps of the method are discussed with reference to FIG. 1 and FIG. 2. It is noted that not all steps described in the flow chart are required, and not all method steps are described in the flow chart.

In step 405 of FIG. 7, one or more waste gases are generated by a semiconductor process tool 100. Chemical byproducts and unreacted gases are then removed from the process tool using, for example, an exhaust pump. The waste gases pass to the local scrubber 130 through process tool outlet line 216.

Next, in step 410 of FIG. 7, the waste gas(es) is thermally oxidized to generate an exhaust gas containing NO and NO₂. This thermal oxidization occurs in the combustion chamber 134 of the local scrubber.

The combustion chamber may cause oxidization through direct combustion, for example by burning natural gas to obtain flames that provide the heat for oxidization. Alternatively, the heat can be provided using electric oxidizers to heat the waste gas without the need for a flame. Finally, oxidization may be performed using a plasma gas system. The gas exiting the combustion chamber are then referred to as an exhaust gas. Due to incomplete combustion, the exhaust gas will also contain undesirable products like nitrogen oxides (NOx), in particular nitric oxide (NO) and nitrogen dioxide (NO₂). NOx can be formed, for example, when diatomic nitrogen and diatomic oxygen are oxidized at high temperatures (thermal NOx), or though the reaction of nitrogen bound in the waste gas with oxygen in the combustion air (fuel NOx), or as nitrogen reacts with radical in the flame front (prompt NOx).

In step 415 of FIG. 7, the exhaust gas travels through the liquid wash chamber 136 of the local scrubber 130 and through a liquid spray. This washing step can collect various acids and/or corrosive gases that may be present in the exhaust gas that might be detrimental to the catalyst in the catalytic reactor 150. As seen in FIG. 1, the washing liquid is collected in sump 142 and the pollutants therein can be treated separately. The washed exhaust gas exits the local scrubber 130 through outlet line 210. In particular embodiments, the exhaust gas exiting the local scrubber has a pH of about 5 or higher (i.e. a higher pH or more alkaline pH), such as about pH 5 to about pH 7 or from about pH 6 to about pH 7.

In step 420 of FIG. 7, reactive oxygen species (ROS) are generated using the ambient temperature plasma generator. In particular embodiments, the plasma generator is operated at a temperature of about 20° C. to about 40° C. The ROS exit the plasma generator through outlet line 214.

In step 425 of FIG. 7, the ROS and the exhaust gas are mixed together and fed into the catalytic reactor 150. As described in FIG. 3, this mixing may occur within the catalytic reactor.

In step 430 of FIG. 7, higher-order nitrogen oxides are generated by the reaction of the ROS and the NO/NO2 within the exhaust gas upon the catalyst. In particular embodiments, the catalytic reactor is sized and/or the exhaust system is operated such that the retention/residence time of the exhaust gases within the catalytic reactor is from about 0.05 seconds to about one second. It has been found that such a retention/residence time is sufficient to obtain an NOx removal efficiency of about 90% to about 100%. Put another way, about 90% to about 100% of the NOx upstream of the catalytic reactor is captured/converted and is not detected downstream of the catalytic reactor. The relative humidity of the exhaust gas and/or the environment within the catalytic reactor may range from about 35% to about 90%, and in particular embodiments is desirably from about 70% to about 90%. In this regard, the humidity is high due to the use of the liquid wash chamber in the local scrubber. In some particular embodiments, the temperature within the catalytic reactor is 80° C. or less, including from about 25° C. to about 60° C., or from about 25° C. to about 50° C., or from about 25° C. to about 40° C. This may vary depending on the temperature of the exhaust gas after combustion and cooling in the liquid wash chamber, and can be controlled as desired. Other ranges and values for each of these parameters are within the scope of the present disclosure.

Next, in step 435 of FIG. 7, the treated exhaust gas exits the catalytic reactor through outlet line 212, which sends the exhaust gas to a central air treatment system 190. In step 440 of FIG. 7, the NOx concentration in the exhaust gas is measured, for example using NOx inline sensor 194. In some embodiments, if the NOx concentration is still too high, as indicated in step 445 of FIG. 7, the exhaust gas can be sent back through recycle line 218 to a point upstream of the catalytic reactor to pass through the catalytic reactor again.

The methods and systems of the present disclosure have several advantages. Injecting reducing agents such as ammonia for selective catalytic reduction (SCR) can result in additional ammonia slip emissions, and such reducing agents are not needed. NOx efficiency can be increased from about 50% to a level of 90% or greater at the local scrubber, which reduces potential slip emissions between the local scrubber and the central air treatment system. SCR typically requires high temperature conditions, whereas the catalytic reactor can be operated at ambient temperatures, reducing operating costs. The catalytic process is fast and can be performed in complex atmospheres.

Some embodiments of the present disclosure thus relate to methods for improving capture of nitrogen oxides from an exhaust gas. A waste gas is thermally oxidized to generate the exhaust gas containing NO and NO₂. Reactive oxygen species (ROS) are generated using an ambient temperature plasma generator. The exhaust gas and the ROS are fed into a catalytic reactor containing a catalyst that converts the NO and NO₂ in the exhaust gas into higher-order nitrogen oxides NₓO_{y} where x and y are both integers and x≥2.

Other embodiments disclosed herein relate to methods for improving capture of nitrogen oxides from a semiconductor manufacturing process. A waste gas is received from a dry process tool. The waste gas is thermally oxidized to generate an exhaust gas containing NO and NO₂. The exhaust gas is passed through a liquid wash chamber to remove acids from the exhaust gas. Reactive oxygen species (ROS) are generated using an ambient temperature plasma generator. The exhaust gas and the ROS are fed into a catalytic reactor that contains a catalyst comprising manganese and a promoter on a monolith support to convert NO and NO₂ in the exhaust gas into higher-order nitrogen oxides NₓO_{y} where x and y are both integers and x≥2. The exhaust gas exiting the catalytic reactor is sent to a central air treatment system.

Also described in various embodiments herein are exhaust gas treatment systems comprising an ambient temperature plasma generator for generating reactive oxygen species (ROS); and a catalytic reactor. The catalytic reactor includes an ROS injection port fluidly connected to the ambient temperature plasma generator. A reaction chamber contains a catalyst comprising manganese and a promoter on a monolith support.

The treatment system may include a local scrubber upstream of the catalytic reactor. The local scrubber may include a combustion chamber and a liquid wash chamber upstream of the liquid wash chamber.

The treatment system may further comprise an outlet line from the catalytic reactor, an NOx sensor for measuring downstream NOx concentration of an exhaust gas, and a recycle line for recycling the exhaust gas upstream of the catalytic reactor.

The methods, systems, and devices of the present disclosure are further illustrated in the following non-limiting working example, it being understood that the example is intended to be illustrative only and that the disclosure is not intended to be limited to the materials, conditions, process parameters and the like recited herein.

### EXAMPLES

Experiments were conducted using a local scrubber and a catalytic reactor. Two different catalysts were used. Catalyst A was manganese with an iron promoter in a 2:1 molar ratio. Catalyst B was manganese with a cobalt promoter in a 2:1 molar ratio.

The local scrubber used natural gas for direct combustion. An exhaust gas had a flow rate of 1.5 CMM (cubic meters per minute). The natural gas had a flow rate of 25 liters per minute (LPM), and the O2 flow to the ambient temperature plasma generator had a flow rate of 50 LPM. The experiments were conducted at room temperature.

When the plasma generator power input was 800 watts and the NOx inlet concentration was 166 ppm, the NOx removal efficiency was greater than 90% with no residual ozone.

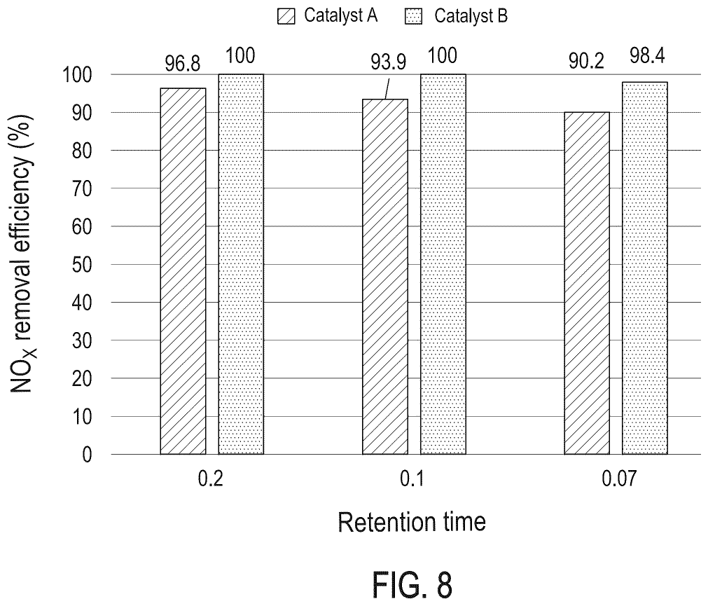

FIG. 8 is a bar graph showing NOx removal efficiency versus retention time. Retention times of 0.2 seconds, 0.1 second, and 0.07 seconds were measured against an NOx inlet concentration of 500 ppm. As can be seen here, Catalyst A had an NOx removal efficiency greater than 90% even at a short retention time of 0.07 seconds, while Catalyst B had a removal efficiency of 100% at a retention time of 0.1 seconds.

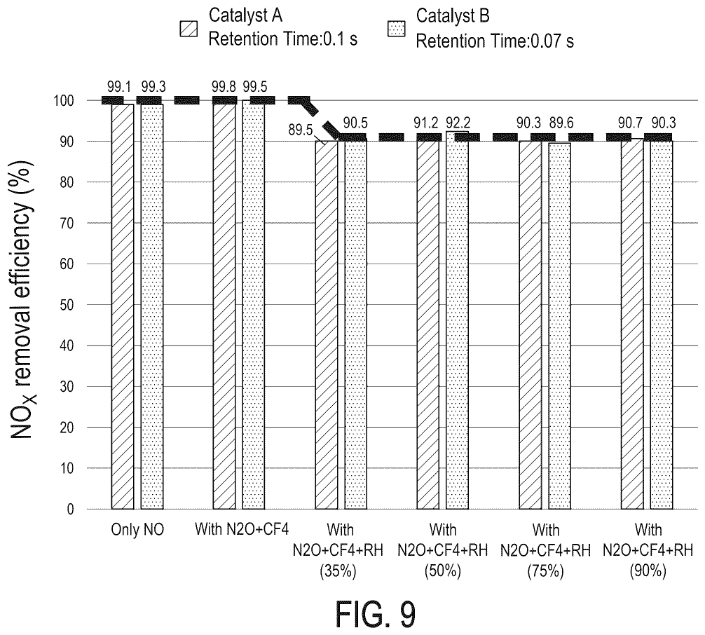

FIG. 9 is a bar graph showing NOx removal efficiency versus relative humidity in a complex atmosphere that also contained 100 ppm N₂O and 50 ppm CF₄. The relative humidity was varied from 35% to 90%. The results for Catalyst A were measured at a retention time of 0.1 seconds, and the results for Catalyst B were measured at a retention time of 0.7 seconds.

As seen in the two bars on the far left side, the NOx removal efficiency was close to 100% even in the presence of N₂O and CF₄, indicating the presence of these other molecules did not affect the ability of the catalyst to react with NO and NO₂. Continuing, the NOx removal efficiency decreased and was relatively constant for both catalysts at relative humidities of 35% to 90%. It is expected the removal efficiency would be higher at longer retention times.

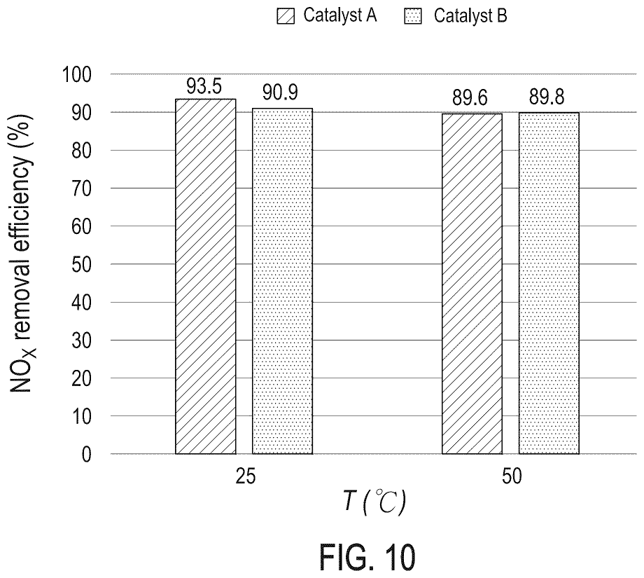

FIG. 10 is a bar graph showing NOx removal efficiency versus temperature. The NOx removal efficiency was close to 90% at 50° C., and higher at 25° C.

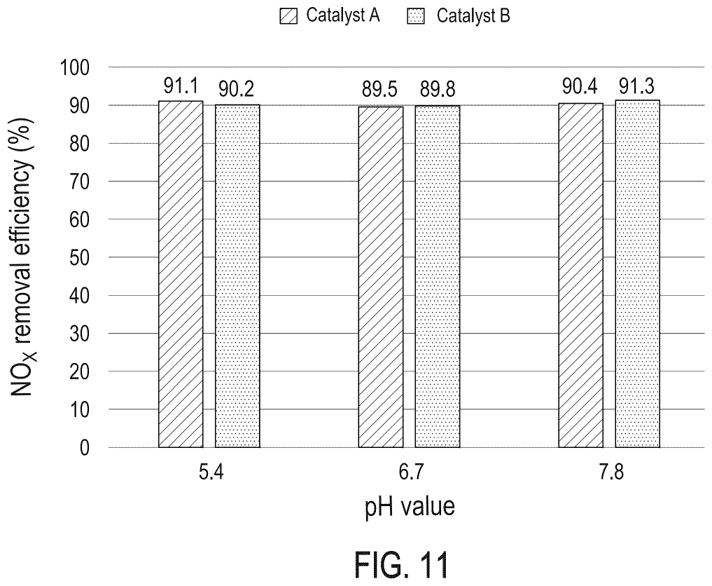

FIG. 11 is a bar graph showing NOx removal efficiency versus pH of the exhaust gas. pH values of 5.4, 6.7, and 7.8 were tested. The NOx removal efficiency was close to 90% or higher at all values.

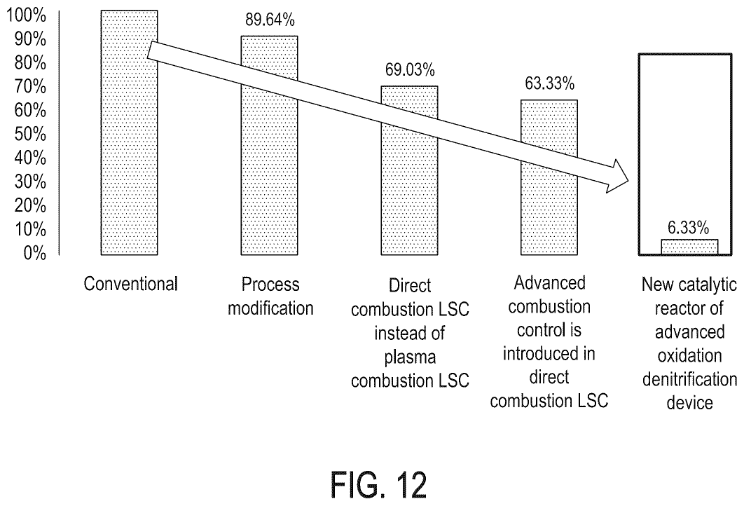

FIG. 12 is a schematic illustration showing how the stacking of various exhaust control processes can improve NOx removal efficiency. Starting on the left hand side, 100% is the starting value using conventional processes. With some process modifications, the NOx emissions can be reduced to 89.64%. If direct combustion is used in the local scrubber instead of plasma combustion, the NOx emissions can be further reduced to 69.03% of the conventional process. Using advanced combustion control, the NOx emissions can be further reduced to 63.33% of the conventional process. Using the catalytic reactor with ambient temperature plasma generator, the NOx emissions can be further reduced to 6.33% of the conventional process. Taken together, NOx emissions can be reduced by almost 94%.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for improving capture of nitrogen oxides from an exhaust gas generated by a semiconductor manufacturing process, comprising:
thermally oxidizing a waste gas to generate the exhaust gas containing NO and NO₂;
generating reactive oxygen species (ROS) using an ambient temperature plasma generator; and
feeding the exhaust gas and the ROS into a catalytic reactor containing a catalyst that converts the NO and NO₂ in the exhaust gas into higher-order nitrogen oxides NₓO_{y} where x and y are both integers and x≥2.

2. The method of claim 1, further comprising passing the exhaust gas through a local scrubber prior to feeding the exhaust gas into the catalytic reactor.

3. The method of claim 1, wherein the catalyst comprises manganese and a promoter.

4. The method of claim 3, wherein a molar ratio of the manganese to the promoter is from about 1.5:1 to about 2.5:1.

5. The method of claim 3, wherein the promoter is iron, cobalt, or cerium.

6. The method of claim 3, wherein the catalyst is impregnated into a monolith support.

7. The method of claim 3, wherein the catalyst does not contain Al, Ca, Sr, Ba, L, Ag, In, Ni, Ti, or Pt.

8. The method of claim 1, wherein the waste gas is generated by a CVD, PVD, or dry etch tool.

9. The method of claim 1, wherein the exhaust gas has a pH of about 5 or higher prior to being fed into the catalytic reactor.

10. The method of claim 1, wherein the ambient temperature plasma generator operates at a temperature of about 20° C. to about 40°C.

11. A method for improving capture of nitrogen oxides from a semiconductor manufacturing process, comprising:
receiving a waste gas from a dry process tool;
thermally oxidizing the waste gas to generate an exhaust gas containing NO and NO₂;
passing the exhaust gas through a liquid wash chamber to remove acids from the exhaust gas;
generating reactive oxygen species (ROS) using an ambient temperature plasma generator;
feeding the exhaust gas and the ROS into a catalytic reactor that contains a catalyst comprising manganese and a promoter on a monolith support to convert NO and NO₂ in the exhaust gas into higher-order nitrogen oxides NₓO_{y} where x and y are both integers and x≥2;
sending the exhaust gas exiting the catalytic reactor to a central air treatment system.

12. The method of claim 11, wherein a retention time of the exhaust gas in the catalytic reactor is from about 0.1 seconds to about 1 second.

13. The method of claim 11, wherein a relative humidity of the exhaust gas in the catalytic reactor is from about 35% to about 90%.

14. The method of claim 11, wherein a temperature of the exhaust gas in the catalytic reactor is about 80° C. or lower.

15. The method of claim 11, wherein a temperature of the exhaust gas in the catalytic reactor is from about 25° C. to about 40°C.

16. The method of claim 11, wherein a pH of the exhaust gas in the catalytic reactor is from about 5 to about 7.

17. An exhaust gas treatment system for a semiconductor process tool, comprising:
an ambient temperature plasma generator for generating reactive oxygen species (ROS); and
a catalytic reactor comprising:
an ROS injection port fluidly connected to the ambient temperature plasma generator; and
a reaction chamber that contains a catalyst comprising manganese and a promoter on a monolith support.

18. The treatment system of claim 17, further comprising a local scrubber upstream of the catalytic reactor.

19. The treatment system of claim 18, further comprising the semiconductor process tool upstream of the local scrubber.

20. The treatment system of claim 17, further comprising an outlet line from the catalytic reactor, an NOx sensor for measuring downstream NOx concentration of an exhaust gas, and a recycle line for recycling the exhaust gas upstream of the catalytic reactor.
